(19) United States
(12) Patent Application Publication
(10) Pub. No.: US 2025/0141266 A1
(43) Pub. Date: May 1, 2025

(54) ELECTRONIC DEVICE HAVING MAGNET STRUCTURE FOR SUPPORING WIRELESS CHARGING

(71) Applicant: SAMSUNG ELECTRONICS CO., LTD., Suwon-si (KR)

(72) Inventors: Bumjin PARK, Suwon-si (KR); Jedok KIM, Suwon-si (KR); Seho PARK, Suwon-si (KR); Sungku YEO, Suwon-si (KR); Hana CHOE, Suwon-si (KR)

(21) Appl. No.: 18/824,137

(22) Filed: Sep. 4, 2024

Related U.S. Application Data
(63) Continuation of application No. PCT/KR2024/012051, filed on Aug. 13, 2024.

(30) Foreign Application Priority Data
Oct. 31, 2023 (KR) 10-2023-0147998
Jan. 24, 2024 (KR) 10-2024-0010841

(51) Int. Cl. H02J 50/10; H02J 7/00

(52) U.S. Cl. CPC H02J 50/10; H02J 7/0042

(57) ABSTRACT

An electronic device (e.g., a power supply device or a power receiving device) includes a housing including a first side of the electronic device and a second side opposite to the first side, a wireless charging coil disposed in the housing, and a magnet structure disposed in the housing to surround the coil and including a plurality of magnet pieces including a first magnet piece and a second magnet piece. The first magnet piece includes a first outer magnetized area having an N pole facing the first side, a first inner magnetized area disposed closer to the coil than the first outer magnetized area and having an S pole facing the first side, and a first non-magnetized area disposed between the first outer magnetized area and the first inner magnetized area. The second magnet piece includes a second outer magnetized area having an N pole facing the first side, a second inner magnetized area disposed closer to the coil than the second outer magnetized area and having an S pole facing the first side, and a second non-magnetized area disposed between the second outer magnetized area and the second inner magnetized area. The first magnet piece has a first magnetic force and the second magnet piece has a second magnetic force different from the first magnetic force.

### CROSS-REFERENCE TO RELATED APPLICATIONS

This application is a continuation of International Application No. PCT/KR2024/012051 designating the United States, filed on Aug. 13, 2024, in the Korean Intellectual Property Receiving Office and claiming priority to Korean Patent Application Nos. 10-2023-0147998, filed on Oct. 31, 2023, and 10-2024-0010841, filed on Jan. 24, 2024, in the Korean Intellectual Property Office, the disclosures of each of which are incorporated by reference herein in their entireties.

### BACKGROUND

### Field

The disclosure relates to an electronic device having a magnet structure configured to support wireless charging.

### Description of Related Art

In a wireless charging system, a battery may be wirelessly charged by using a coil. For example, the wireless charging system may include a power supply device (e.g., a charging pad or charging cradle) with a transmitting coil and a power receiving device (e.g., a smartphone, smart watch, or wireless earphone charging case (or cradle) with a receiving coil. When the axis of the transmitting coil is aligned with the axis of the receiving coil, the two coils may be electrically coupled so that power can be transferred from the transmitting coil to the receiving coil. The power receiving device may charge a battery using the power received from the power supply device via the receiving coil.

The above information is provided as a related art for the purpose of helping understanding of the disclosure. No claim or determination is made as to whether any of the foregoing may be applied as a prior art related to the disclosure.

When the two axes are out of alignment, the electrical coupling between the two coils decreases, resulting in lower charging efficiency.

Magnetic structures may be placed around the transmitting coil and the receiving coil. For example, the magnet structures may be configured to exert a pull force (e.g., an attractive force) on each other when the two axes of the transmitting coil-side magnet structure and the receiving coil-side magnet structure are aligned. Even when an external impact is applied to the two electronic devices, the two axes may be maintained in alignment without misalignment due to the pull force acting between the two magnet structures. Therefore, efficient wireless charging is possible.

The pull force acting between the two magnet structures may cause discomfort to a user when the user attempts to detach the power receiving device from the power supply device. The magnetic force generated from the magnet structure has a negative effect on electronic components (e.g., a digitizer or a camera) disposed around the magnet, and as a result, the electronic components may malfunction.

### SUMMARY

Embodiments of the disclosure may provide magnet structures configured to maintain the two axes in alignment without misalignment during wireless charging, and configured to be easily detached when a user wants to separate the power receiving device from the power supply device. Magnetic structures according to various embodiments may be configured to prevent or prevent a malfunction of electronic components disposed around the structures. Magnet structures according to various embodiments may be applied to the above-described power receiving device and/or power supply device.

The technical problems to be addressed by this disclosure are not limited to those described above, and other technical problems, which are not described above, may be clearly understood by a person ordinarily skilled in the related art to which this disclosure belongs.

According to an example embodiment, an electronic device includes: a housing including a first side of the electronic device and a second side opposite to the first side, a wireless charging coil disposed in the housing, and a magnet structure disposed in the housing to surround the coil and including a plurality of magnet pieces including a first magnet piece and a second magnet piece. The first magnet piece may include a first outer magnetized area having an N pole facing the first side, a first inner magnetized area disposed closer to the coil than the first outer magnetized area and having an S pole facing the first side, and a first non-magnetized area disposed between the first outer magnetized area and the first inner magnetized area. The second magnet piece may include a second outer magnetized area having an N pole facing the first side, a second inner magnetized area disposed closer to the coil than the second outer magnetized area and having an S pole facing the first side, and a second non-magnetized area disposed between the second outer magnetized area and the second inner magnetized area. The first magnet piece may have a first magnetic force, and the second magnet piece may have a second magnetic force different from the first magnetic force.

According to an example embodiment, a portable electronic device includes: a housing including a first side of the electronic device and a second side opposite to the first side, a wireless charging coil disposed in the housing, a display disposed on the housing and visible through the first side, a battery disposed in the housing, and a magnet structure disposed in the housing to surround the coil and including a plurality of magnet pieces including a first magnet piece and a second magnet piece. The first magnet piece may include a first outer magnetized area having an N pole facing the first side, a first inner magnetized area disposed closer to the coil than the first outer magnetized area and having an S pole facing the first side, and a first non-magnetized area disposed between the first outer magnetized area and the first inner magnetized area. The second magnet piece may include a second outer magnetized area having an N pole facing the first side, a second inner magnetized area disposed closer to the coil than the second outer magnetized area and having an S pole facing the first side, and a second non-magnetized area disposed between the second outer magnetized area and the second inner magnetized area. The first magnet piece may have a first magnetic force, and the second magnet piece may have a second magnetic force different from the first magnetic force.

According to various example embodiments of the disclosure, the power receiving device can be easily separated from the power supply device by a user. Malfunction of electronic components disposed around the magnet structure can be prevented or reduced. Various other effects identified directly or indirectly through the disclosure can be provided.

### BRIEF DESCRIPTION OF THE DRAWINGS

FIG. 1 is a block diagram of an electronic device according to various embodiments in a network environment.

FIG. 2 is a perspective view of a wireless charging system to which a magnet structure according to various embodiments is applicable.

FIG. 3 is a view illustrating a layout of coils and magnet structures for wireless charging in the wireless charging system.

FIG. 4A is a view illustrating a magnet structure according to an embodiment.

FIG. 4B is a cross-sectional view of the magnet structure taken along line A-A′ in FIG. 4A.

FIGS. 5A, 5B, and 5C are views for describing changes in shear force and pull force (e.g., attractive force) depending on a change in the distance between the center of a third first magnet structure and the center of a second magnet structure adjacent to the first magnet structure when the magnet pieces in the first magnet structure are configured such that the sizes thereof are all the same.

FIG. 6A is a view illustrating a magnet structure according to an embodiment. FIGS. 6B and 6C are cross-sectional views of a first magnet piece and a second magnet piece, respectively, in which magnetized areas are configured to have different widths, according to an embodiment. The cross section of the first magnet piece in FIG. 6B is a cross section of the magnet structure taken along line B-B′ in FIG. 6A. The cross section of the second magnet piece in FIG. 6B is a cross section of the magnet structure taken along line C-C′ in FIG. 6A.

FIG. 7A is a view illustrating a magnet structure according to an embodiment. FIGS. 7B and 7C are cross-sectional views of a first magnet piece and a second magnet piece, respectively, in which the magnetized areas are configured to have different widths, according to an embodiment. The cross section of the first magnet piece in FIG. 7B is a cross section of the magnet structure taken along line D-D′ in FIG. 7A. The cross section of the second magnet piece in FIG. 7C is a cross section of the magnet structure taken along line E-E′ in FIG. 7A.

FIG. 8A is a view illustrating a magnet structure according to an embodiment. FIGS. 8B and 8C are cross-sectional views of a first magnet piece and a second magnet piece, respectively, which are configured to have different widths of magnetized areas, according to an embodiment. The cross section of the first magnet piece in FIG. 8B is a cross section of the magnet structure of FIG. 8A taken along line F-F′. The cross section of the second magnet piece in FIG. 8C is a cross section of the magnet structure taken along line G-G′ in FIG. 8A.

FIGS. 9A and 9B are cross-sectional views of a first magnet piece and a second magnet piece, respectively, which are configured to have different shapes, according to an embodiment.

FIG. 10A illustrates changes in shear force and pull force depending on a change in the distance between the center of the first magnet structure and the center of the second magnet structure adjacent thereto when the first magnet structure is implemented as a single magnet structure.

FIG. 10B illustrates changes in shear force and pull force depending on a change in the distance between the center of a third magnet structure and the center of a second magnet structure adjacent thereto when the third magnet structure is implemented as a multi-magnet structure.

FIG. 11 illustrates the rear surface of an electronic device 1101 having a magnet structure configured according to an embodiment.

Hereinafter, embodiments of the disclosure will be described in detail with reference to the drawings such that a person ordinarily skilled in the art to which the disclosure belongs can easily carry out the disclosure. However, the disclosure may be implemented in many different forms, and is not limited to the embodiments described herein. In connection with a description made with reference to the drawings, the same or similar reference numerals may be used for the same or similar elements. In addition, in the drawings and related descriptions, descriptions of well-known functions and configurations may be omitted for clarity and brevity.

### DETAILED DESCRIPTION

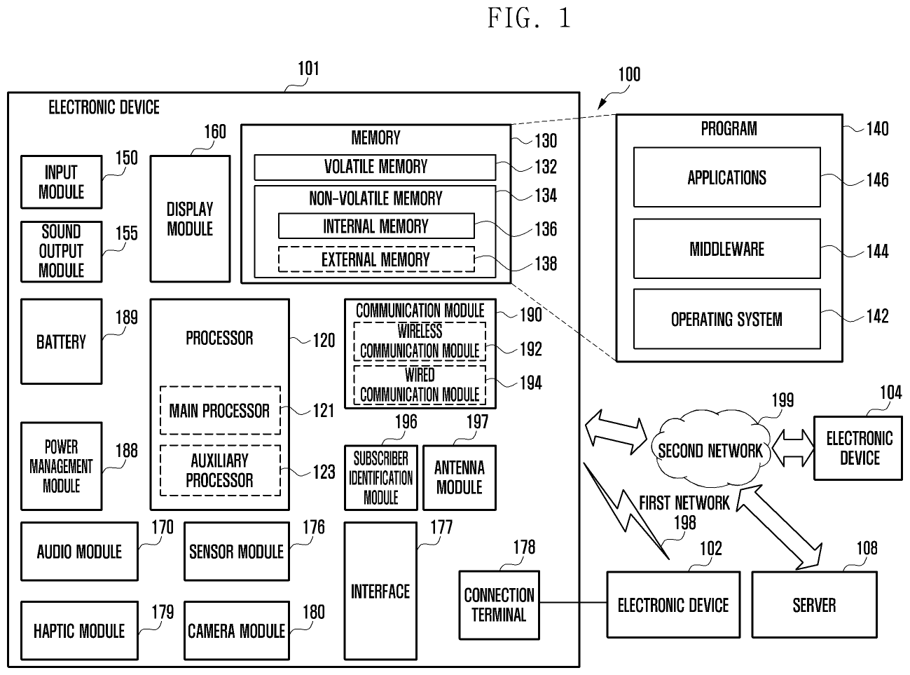

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

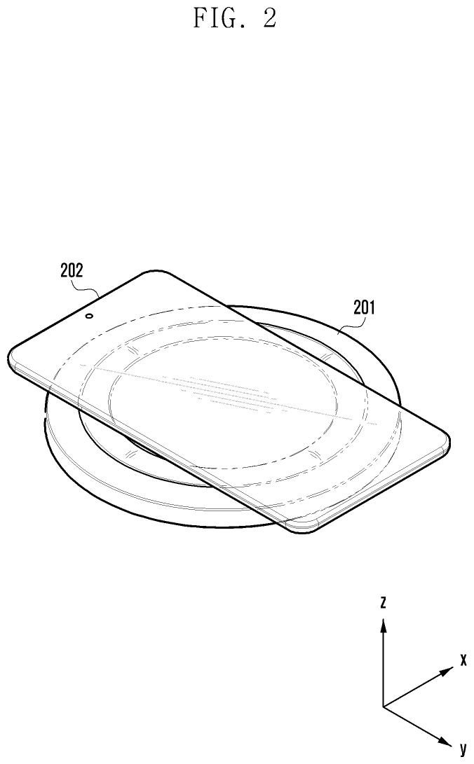

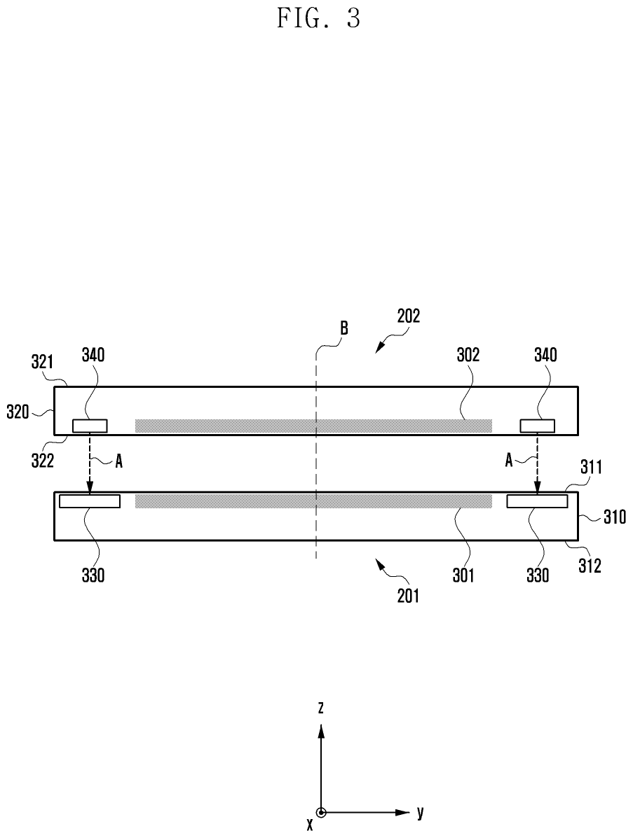

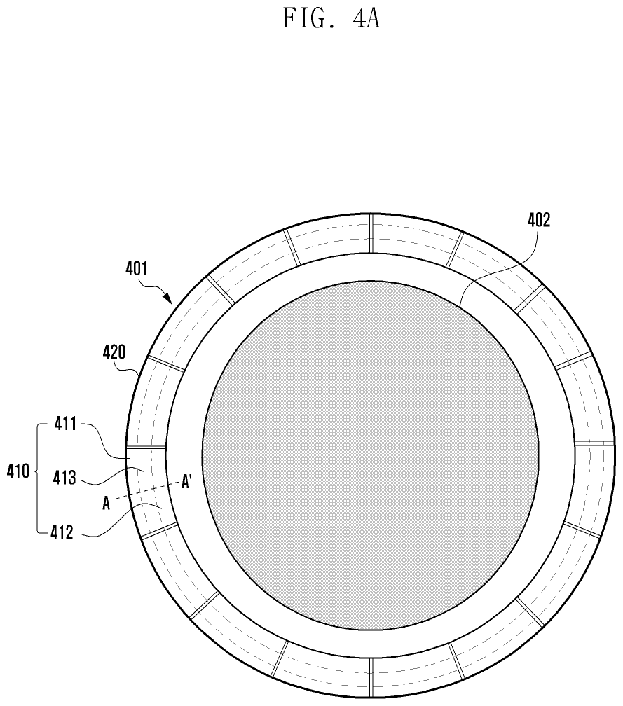

FIG. 2 is a perspective view of a wireless charging system to which a magnet structure according to various embodiments is applicable. FIG. 3 is a view illustrating an arrangement of coils 301 and 302 and magnet structures 330 and 340 for wireless charging in the wireless charging system.

Referring to FIG. 2, a power supply device (e.g., the electronic device 102 in FIG. 1 or a wireless charging pad) 201 may transmit power wirelessly by using a transmitting coil. For example, the power supply device 201 may be a wireless charging pad configured to supply power received from a first external electronic device (e.g., a travel adapter (TA)) to a second external electronic device (e.g., the power receiving device 202) via the transmitting coil. The power receiving device (e.g., the electronic device 101 in FIG. 1 or a smartphone) 202 may be configured to wirelessly receive power by using the receiving coil in a state close to the power supply device 201 (e.g., the state of being mounted on the charging pad), and to charge a battery (e.g., the battery 189 in FIG. 1) by using the received power.

Referring to FIG. 3, in the power supply device 201, a transmitting coil 301 may be disposed inside a first housing 310 of the power supply device 201. For example, the first housing 310 may include a cover 311 that defines the front surface of the power supply device 201 (e.g., the surface on which the power receiving device 202 is mounted) and a cover 312 that defines the opposite surface (the rear surface) to the front surface. The transmitting coil 301 may be disposed inside the first housing 310 adjacent to the front cover 311. The transmitting coil 301 may be a spiral type coil wound several times clockwise or counterclockwise around an axis perpendicular to the front surface. In the power receiving device 202, the receiving coil 302 may be disposed inside a second housing 320 of the power receiving device 202. For example, the second housing 320 may include a cover 321 that defines the front surface (the surface where a display is exposed) of the power receiving device 202 and a cover 322 that defines the rear surface of the power receiving device 202. The receiving coil 302 may be disposed inside the second housing 320 adjacent to the rear cover 322. The receiving coil 302 may be a spiral type coil wound several times clockwise or counterclockwise around an axis perpendicular to the rear surface.

Referring again to FIG. 3, a first magnet structure 330 configured to support power transmission of the transmitting coil 301 may be disposed inside the first housing 310. For example, when viewed the front cover 311 of the power supply device 201 while facing the front cover 311, the first magnet structure 330 may be disposed adjacent to the transmitting coil 301 without overlapping the transmitting coil 301. A second magnet structure 340 configured to support power reception of the receiving coil 302 may be disposed inside the second housing 320. For example, when viewed the rear cover 322 of the power receiving device 202 while facing the rear cover 322, the second magnet structure 340 may be disposed adjacent to the receiving coil 302 without overlapping the receiving coil 302. When the power receiving device 202 is adjacent to the power supply device 201, the first magnet structure 330 and the second magnet structure 340 may be configured to exert an pull force A pulling each other. Due to the pull force A, the center of the transmitting coil 301 and the center of the receiving coil 302 are aligned on an axis B parallel to the z-axis, thereby increasing the efficiency of receiving power.

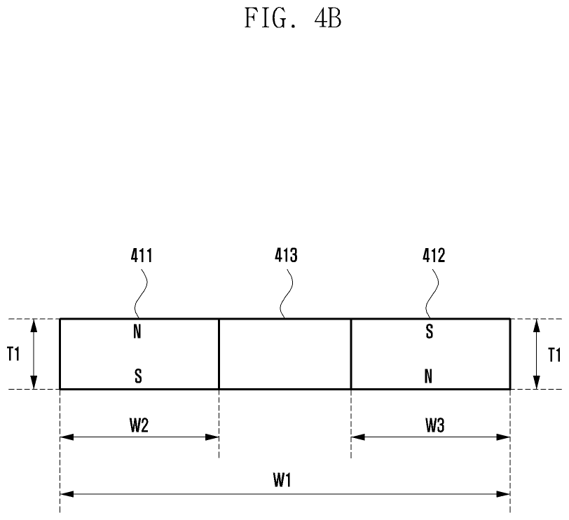

FIG. 4A illustrates a magnet structure 401 according to an embodiment. FIG. 4B is a cross-sectional view of the magnet structure 401 taken along line A-A′ in FIG. 4A.

Referring to FIG. 4A, the magnet structure 401 (e.g., the first magnet structure 330 or the second magnet structure 340) may have a ring shape surrounding a coil 402. For example, the coil 402 (e.g., the transmitting coil 301 or the receiving coil 302) may be disposed inside the magnet structure 401 not to overlap the magnet structure 401 when viewed the front surface or the rear surface of the housing while facing the front surface or the rear surface of the housing in which the magnet structure 401 is disposed.

The magnet structure 401 may include a plurality of magnet pieces 420 arranged in a circular shape along the coil 402 disposed therein. The magnet pieces may each include an outer magnetized area, an inner magnetized area disposed closer to the coil 402 than the outer magnetized area, and a non-magnetized area disposed between the outer magnetized area and the inner magnetized area. All of the outer magnetized areas may be configured such that one (the same polarity) of the N and S poles faces the front surface (e.g., in the z-axis direction in FIGS. 2 and 3). All of the inner magnetized areas may be configured such that other (the same polarity) of the N and S poles faces the front surfaces. In the outer magnetized areas, a first polarity may be configured to face the front surface, and in the inner magnetized area, a second polarity different from the first polarity may be configured to face the front surface. For example, referring to FIGS. 4A and 4B, the first magnet piece 410 may include a first outer magnetized area 411 configured such that an N pole faces the front surface, a first inner magnetized area 412 configured such that an S pole faces the front surface, and a first non-magnetized area 413 disposed between the first outer magnetized area 411 and the first inner magnetized area 412.

The sizes (e.g., widths and thicknesses) of the magnet pieces in the magnet structure 401 may all be the same. For example, referring to FIG. 4B, the widths of the magnet pieces may all be the same as W1. The outer magnetized areas may be configured such that the widths thereof are all the same as W2. The inner magnetized areas may be configured such that the widths thereof are all the same as W3. W3 may be the same as W2. The outer magnetized areas and the inner magnetized areas may be configured such that the thicknesses of the outer magnetized areas and the inner magnetized areas are all the same as T1.

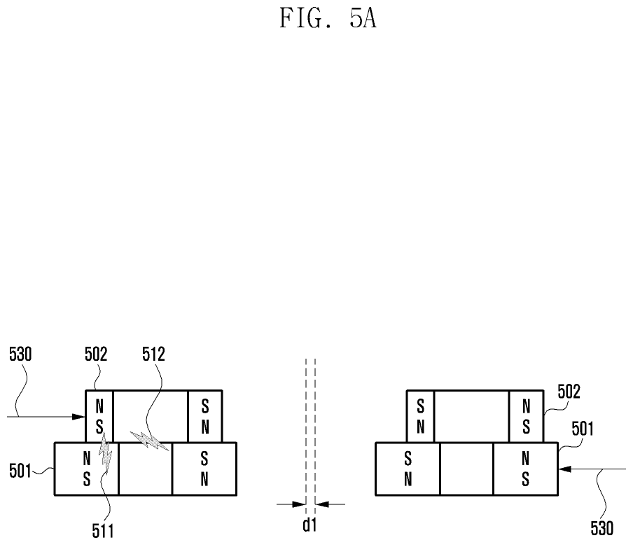

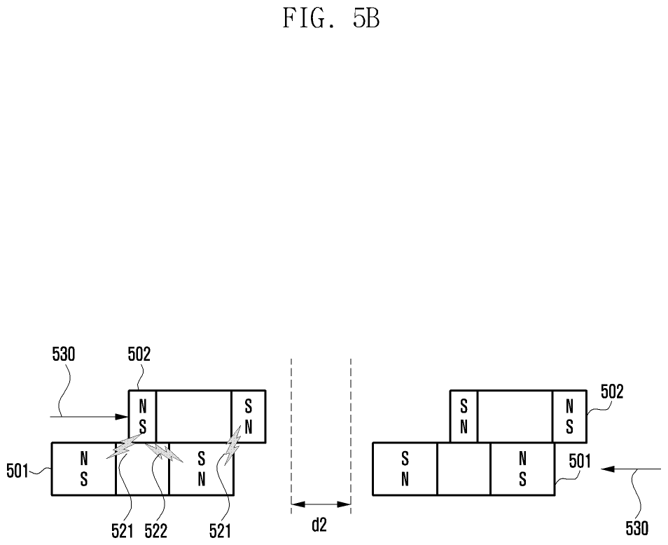

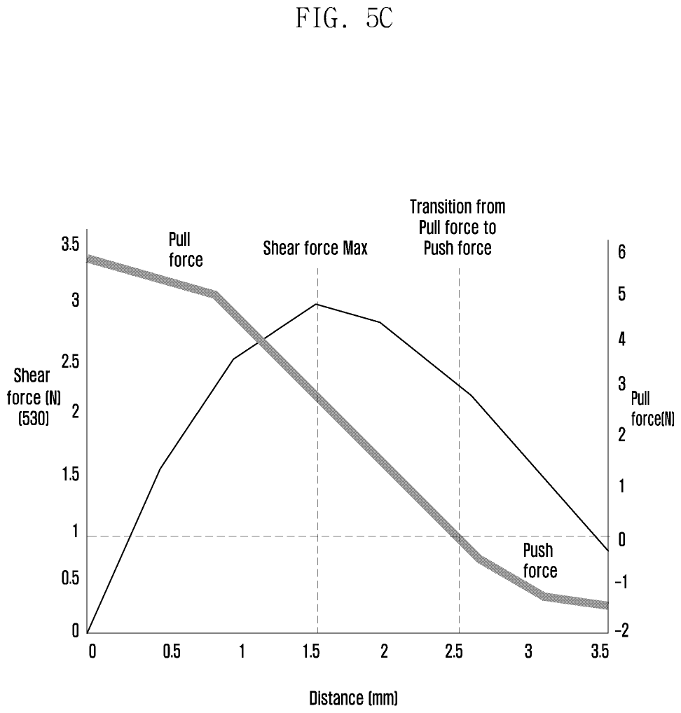

FIGS. 5A, 5B, and 5C are views for describing changes in shear force and pull force depending on a change in the distance between the center of a first magnet structure 501 and the center of a second magnet structure 502 adjacent to the first magnet structure 501 when the magnet pieces in the first magnet structure 501 are configured such that the sizes (e.g., the widths and the thicknesses) thereof are all the same.

Referring to FIG. 5A, the first magnet structure 501 may be a magnet structure (e.g., the first magnet structure 330 in FIG. 3) configured in one of a power supply device (e.g., the power supply device 201 in FIG. 3) and a power receiving device (e.g., the power receiving device 202 in FIG. 3). The second magnet structure 502 may be a magnet structure (e.g., the second magnet structure 340 in FIG. 3) configured in another one of the power supply device and the power receiving device. When the distance between the center of the first magnet structure 501 and the center of the second magnet structure 502 is d1, the pull force 511 acting between the two structures 501 and 052 may be stronger than the push force (e.g., repulsive force) 512.

Referring to FIG. 5B, when the distance between the center of the first magnet structure 501 and the center of the second magnet structure 502 increases from d1 to d2, the pull force 521 acting between the two structures 501 and 502 may be weakened, for example, to be equal to the push force 522. When the distance becomes greater than d2, the push force 522 may become stronger than the pull force 521.

Referring to FIG. 5C, the distance value at which shear force 530 reaches its maximum (MAX) (e.g., d1) (hereinafter, a “first distance value”) and the distance value at which the transition from pull force to push force begins (push force becomes stronger than pull force) (e.g., d2) (hereinafter, referred to as a “second distance value”) may be different. Here, referring to FIG. 5A, the shear force 530 may be defined with a force related to the magnitude of magnetic force between the first magnet structure 501 and the second magnet structure 502 in a horizontal direction (e.g., the direction parallel to the xy plane in FIGS. 2 and 3).

As the first distance value or the second distance value is smaller, the user may easily separate the power receiving device from the power supply device without exerting much force.

As the difference between the second distance value and the first distance value is smaller, the user may easily separate the power receiving device from the power supply device without exerting much force. The first distance value may change depending on the size (e.g., the width and thickness) of the magnetized area of the first magnet structure 501 and/or the strength of the magnetic force of the magnetized area, and the second distance value may also change. For example, as the width of the magnetized area increases, the first distance value may become smaller and the second distance value may also become smaller.

According to various embodiments, the difference between the first distance value and the second distance value may be reduced by configuring the magnet structure such that there is a partial deviation in magnetic force in the magnet structure. Accordingly, it is possible to separate the two magnet structures (i.e., to separate the power receiving device from the power supply device) even with relatively little force. Various embodiments of configuring a magnet structure such that there is a deviation in magnetic force will be described below.

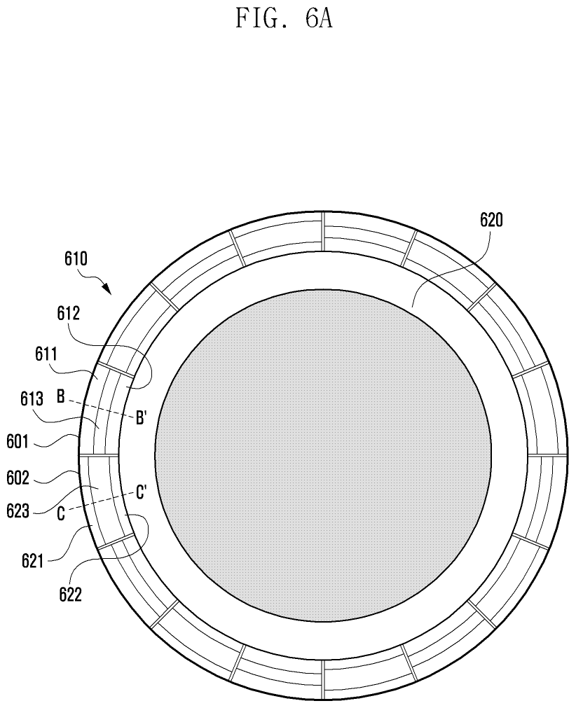

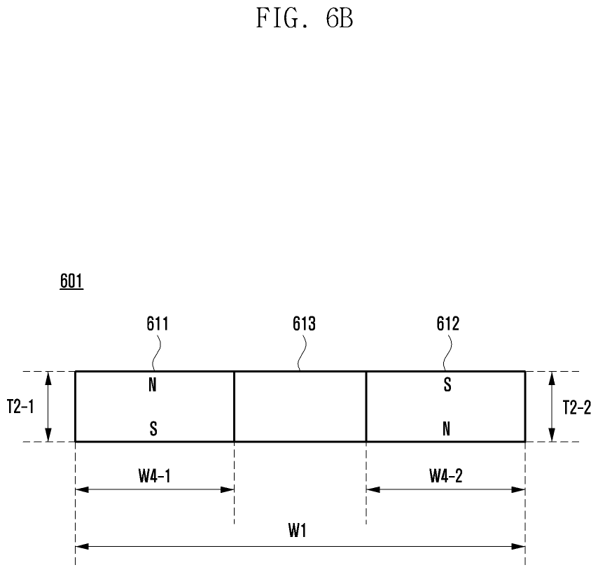

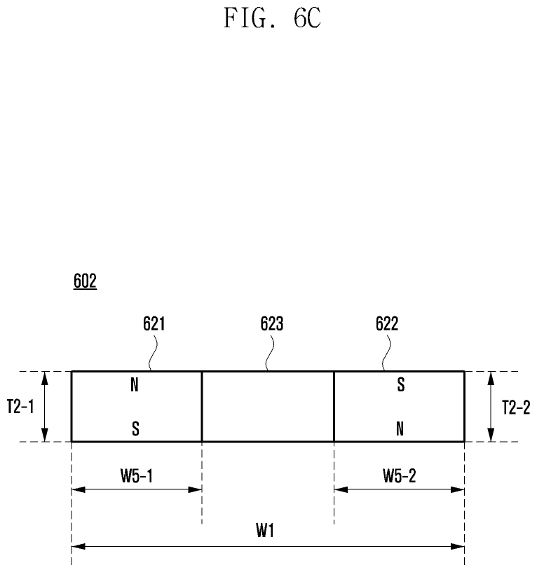

FIG. 6A illustrates a magnet structure 610 according to an embodiment. FIGS. 6B and 6C are cross-sectional views of a first magnet piece 601 and a second magnet piece 602, respectively, in which the magnetized areas are configured to have different widths, according to an embodiment. The cross section of the first magnet piece 601 in FIG. 6B may correspond to the cross section of the magnet structure 610 (e.g., the first magnet structure 330 or the second magnet structure 340 in FIG. 3) taken along line B-B′ in FIG. 6A. The cross section of the second magnet piece 602 in FIG. 6C may correspond to a cross section of the magnet structure 610 taken along line C-C′ in FIG. 6A.

Referring to FIG. 6A, the magnet structure 610 (e.g., the first magnet structure 330 or the second magnet structure 340) may have a ring shape surrounding a coil 620. For example, the coil 620 (e.g., the transmitting coil 301 or the receiving coil 302) may be disposed inside the magnetic structure 610 not to overlap the magnetic structure 610 when viewed the front surface or the rear surface of the housing while facing the front surface or the rear surface of the housing in which the magnetic structure 610 is disposed.

Referring to FIG. 6B, the first magnet piece 601 may include a first outer magnetized area 611 configured such that an N pole faces a first surface of a first side of the housing (e.g., the first surface of the housing) and a second side of the housing (e.g., the second surface of the housing) opposite to the first side, a first inner magnetized area 612 configured such that an S pole faces the first side, and a first non-magnetized area 613 disposed between the first outer magnetized area 611 and the first inner magnetized area 612. In the first outer magnetized area 611, the S pole may face the first side, and in the first inner magnetized area 612, the N pole may face the first side. When the first magnet piece 601 and the second magnet piece 602 are applied to the power supply device 201, the first side may be the front cover 311 (see FIG. 3). When the first magnet piece 601 and the second magnet piece 602 are applied to the power receiving device 202, the first side may be the rear cover 322 (see FIG. 3). The first magnet piece 601 may be configured such that its width is W1. The first outer magnetized area 611 and the first inner magnetized area 612 may be configured such that the width of the first outer magnetized area 611 is W4-1 and the width of the first inner magnetized area 612 is W4-2. W4-1 and W4-2 may be the same. The first outer magnetized area 611 and the first inner magnetized area 612 may be configured such that the thickness of the first outer magnetized area 611 is T2-1 and the thickness of the first inner magnetized area 612 is T2-2. T2-1 and T2-2 may be the same.

Referring to FIG. 6C, the second magnet piece 602 may include a second outer magnetized area 621 configured such that an N pole faces the first side, a second inner magnetized area 622 configured such that an S pole faces the first side, and a second non-magnetized area 623 disposed between the second outer magnetized area 621 and the second inner magnetized area 622. In the second outer magnetized area 621, the S pole may face the first side, and in the second inner magnetized area 622, the N pole may face the first side. The second magnet piece 602 may be configured such that its width is W1. The second outer magnetized area 621 and the second inner magnetized area 622 may be configured such that the width of the second outer magnetized area 621 is W5-1 different from (e.g., smaller than) W4-1, and the width of the second inner magnetized area 622 is W5-2 different from (e.g., smaller than) W4-2. W5-1 and W5-2 may be the same. The second outer magnetized area 621 and the second inner magnetized area 622 may be configured such that the thickness of the second outer magnetized area 621 is T2-1 and the thickness of the second inner magnetized area 622 is T2-2. As described above, the width of the first outer magnetized area 611 and the width of the second outer magnetized area 621 may be different, and the width of the first inner magnetized area 612 and the width of the second inner magnetized area 622 may be different. As a result, the width of the first non-magnetized area 613 and the width of the second non-magnetized area 623 also become different.

According to an embodiment, it is possible to configure a ring-shaped magnet structure (e.g., the magnet structure 401 of FIG. 4) by alternately arranging the first magnet pieces 601 and the second magnet pieces 602 in a circular shape on a substrate (e.g., a plate made of a film).

According to an embodiment, the magnet structure may further include a magnet piece in which the width of the magnetized area is different from the widths of the magnetized areas in the above-described magnet pieces 601 and 602. For example, the width of the third outer magnetized area in the third magnet piece may be different from W4-1 or W5-1. The width of the third inner magnetized area may be different from W4-2 or W5-2. It is possible to configure a ring-shaped magnet structure by alternately arranging the first magnet piece 601, the second magnet piece 602, and the third magnet piece in a circular shape on the substrate.

According to an embodiment, when designing the magnet structure, W4 (W4-1, W4-2) and W5 (W5-1, W5-2) may be determined such that the first distance has as small a value as possible, the second distance has as small a value as possible, or the difference between the first distance value and the second distance value has as small a value as possible.

The above-described first side may be the front surface or the rear surface of the housing of the electronic device (e.g., the power supply device 201 or the power receiving device 202). The same applies to the magnet pieces to be described below.

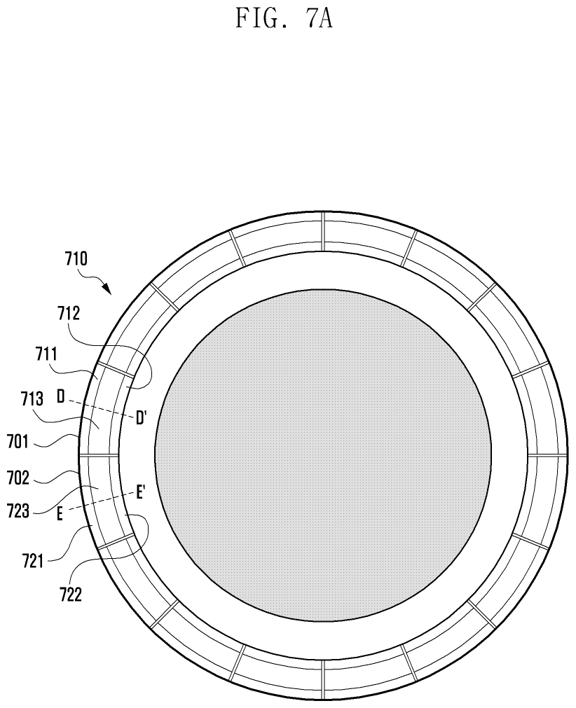

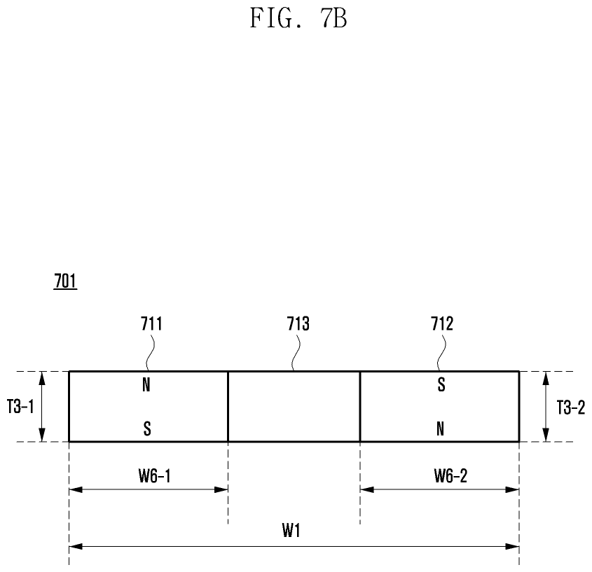

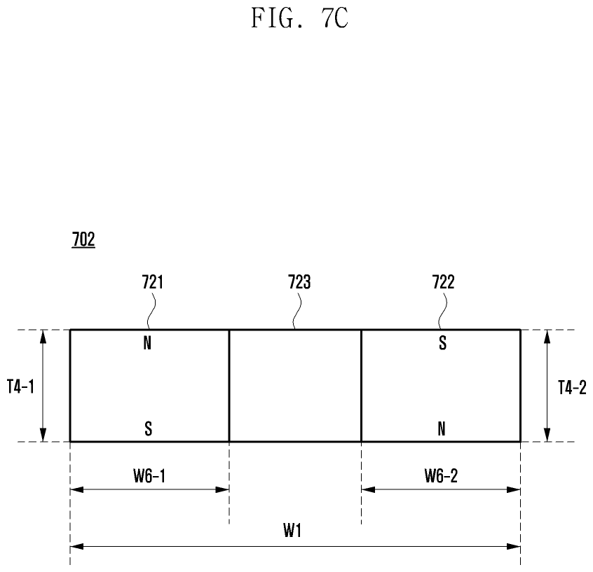

FIG. 7A illustrates a magnet structure 710 according to an embodiment. FIGS. 7B and 7C illustrate cross sections of a first magnet piece 701 and a second magnet piece 702, respectively, in which the thicknesses of magnetized areas are configured to be different, according to an embodiment. The cross section of the first magnet piece 701 in FIG. 7B may correspond to a cross section of the magnet structure 710 taken along line D-D′ in FIG. 7A. The cross section of the second magnet piece 702 in FIG. 7C may correspond to a cross section of the magnet structure 710 taken along line E-E′ in FIG. 7A.

Referring to FIG. 7B, the first magnet piece 701 may include a first outer magnetized area 711 configured such that an N pole faces the first side, a first inner magnetized area 712 configured such that an S pole faces the first side, and a first non-magnetized area 713 disposed between the first outer magnetized area 711 and the first inner magnetized area 712. In the first outer magnetized area 711, the S pole may face the first side, and in the first inner magnetized area 712, the N pole may face the first side. When the first magnet piece 701 and the second magnet piece 702 are applied to the power supply device 201, the first side may be the front cover 311 (see FIG. 3). When the first magnet piece 701 and the second magnet piece 702 are applied to the power receiving device 202, the first side may be the rear cover 322 (see FIG. 3). The first magnet piece 701 may be configured such that its width is W1. The first outer magnetized area 711 and the first inner magnetized area 712 may be configured such that the width of the first outer magnetized area 711 is W6-1 and the width of the first inner magnetized area 712 is W6-2. W6-1 and W6-2 may be the same. The first outer magnetized area 711 and the first inner magnetized area 712 may be configured such that the thickness of the first outer magnetized area 711 is T3-1 and the thickness of the first inner magnetized area 712 is T3-2. T3-1 and T3-2 may be the same.

Referring to FIG. 7C, the second magnet piece 702 may include a second outer magnetized area 721 configured such that an N pole faces the first side, a second inner magnetized area 722 configured such that an S pole faces the first side, and a second non-magnetized area 723 disposed between the second outer magnetized area 721 and the second inner magnetized area 722. In the second outer magnetized area 721, the S pole may face the first side, and in the second inner magnetized area 722, the N pole may face the first side. The second magnet piece 702 may be configured such that its width is W1. The second outer magnetized area 721 and the second inner magnetized area 722 may be configured such that the width of the second outer magnetized area 721 is W6-1 and the width of the second inner magnetized area 722 is W6-2. The second outer magnetized area 721 and the second inner magnetized area 722 may be configured such that the thickness of the second outer magnetized area 721 is T4-1 different from (e.g., larger than) T3-1, and the thickness of the second inner magnetized area 722 is T4-2 different from (e.g., larger than) T3-2. T4-1 and T4-2 may be the same.

According to an embodiment, it is possible to configure a ring-shaped magnet structure (e.g., the magnet structure 401 of FIG. 4) by alternately arranging the first magnet pieces 701 and the second magnet pieces 702 in a circular shape on a substrate (e.g., a plate made of a film).

According to an embodiment, the magnet structure may further include a third magnet piece in which the thickness of the magnetized area is different from the thickness of the magnetized areas in the above-described magnet pieces 701 and 702. For example, in the third magnet piece, the third outer magnetized area and the third inner magnetized area may be configured such that the thicknesses of the third outer magnetized area and the third inner magnetized area are different from T3 and T4. It is possible to configure a ring-shaped magnet structure by alternately arranging the first magnet piece 701, the second magnet piece 702, and the third magnet piece in a circular shape on the substrate.

According to an embodiment, when designing the magnet structure, T3 (T3-1, T3-2) and T4 (T4-1, T4-2) may be determined such that the first distance has as small a value as possible, the second distance has as small a value as possible, or there is no difference between the first distance value and the second distance value if possible.

According to an embodiment, a second outer magnetized area 721 and a second inner magnetized area 722 having a thickness T4 may be configured by stacking two or more magnetic materials layer by layer.

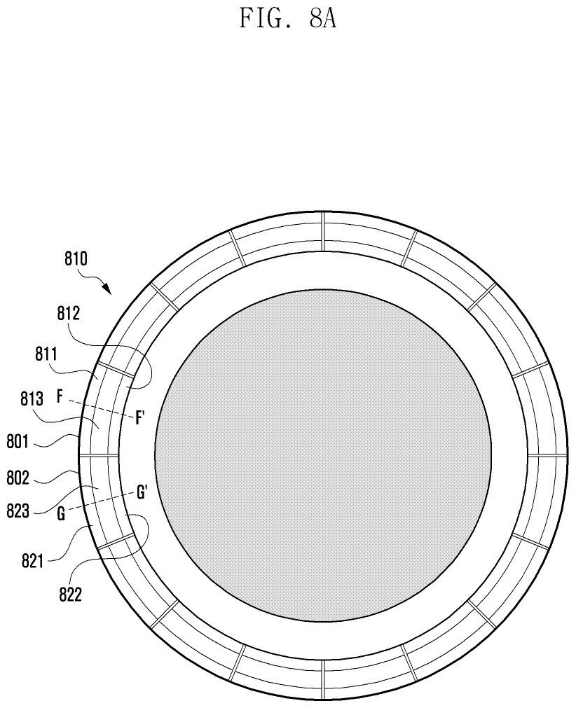

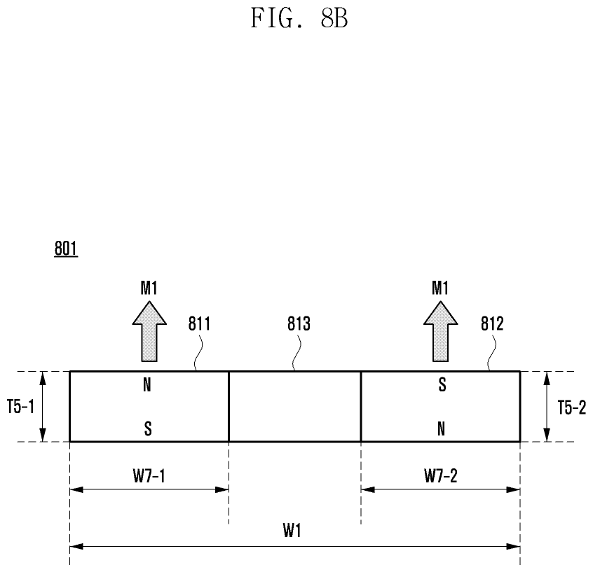

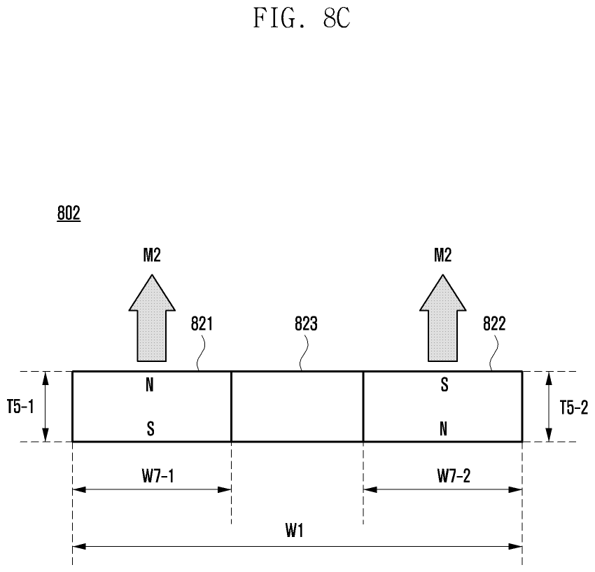

FIG. 8A illustrates a magnet structure 810 according to an embodiment. FIGS. 8B and 8C are cross-sectional views of a first magnet piece 801 and a second magnet piece 802 magnetized to have different magnetic forces, according to an embodiment. The cross section of the first magnet piece 801 in FIG. 8B may correspond to a cross section of the magnet structure 810 taken along line F-F′ in FIG. 8A. The cross section of the second magnet piece 802 in FIG. 8C may correspond to a cross section of the magnet structure 810 taken along line F-F′ in FIG. 8A.

Referring to FIG. 8B, the first magnet piece 801 may include a first outer magnetized area 811 configured such that an N pole faces the first side, a first inner magnetized area 812 configured such that an S pole faces the first side, and a first non-magnetized area 813 disposed between the first outer magnetized area 811 and the first inner magnetized area 812. In the first outer magnetized area 811, the S pole may face the first side, and in the first inner magnetized area 812, the N pole may face the first side. When the first magnet piece 801 and the second magnet piece 802 are applied to the power supply device 201, the first side may be the front cover 311 (see FIG. 3). When the first magnet piece 801 and the second magnet piece 802 are applied to the power receiving device 202, the first side may be the rear cover 322 (see FIG. 3). The first magnet piece 801 may be configured such that its width is W1. The first outer magnetized area 811 and the first inner magnetized area 812 may be configured such that the width of the first outer magnetized area 811 is W7-1 and the width of the first inner magnetized area 812 is W7-2. W7-1 and W7-2 may be the same. The first outer magnetized area 811 and the first inner magnetized area 812 may be configured such that the thickness of the first outer magnetized area 811 is T5-1 and the thickness of the first inner magnetized area 812 is T5-2. T5-1 and T5-2 may be the same. The first outer magnetized area 811 and the first inner magnetized area 812 may be configured to have a magnetic force of M1.

Referring to FIG. 8C, the second magnet piece 802 may include a second outer magnetized area 821 configured such that an N pole faces the first side, a second inner magnetized area 822 configured such that an S pole faces the first side, and a second non-magnetized area 823 disposed between the second outer magnetized area 821 and the second inner magnetized area 822. In the second outer magnetized area 821, the S pole may face the first side, and in the second inner magnetized area 822, the N pole may face the first side. The second magnet piece 802 may be configured such that its width is W1. The second outer magnetized area 821 and the second inner magnetized area 822 may be configured such that the width of the second outer magnetized area 821 is W7-1 and the width of the second inner magnetized area 822 is W7-2. The second outer magnetized area 821 and the second inner magnetized area 822 may be configured such that the thickness of the second outer magnetized area 821 is T5-1 and the thickness of the second inner magnetized area 822 is T5-2. The second outer magnetized area 821 and the second inner magnetized area 822 may be configured to have a magnetic force of M2 different from (e.g., stronger than) M1.

According to an embodiment, it is possible to configure a ring-shaped magnet structure (e.g., the magnet structure 401 of FIG. 4) by alternately arranging the first magnet pieces 801 and the second magnet pieces 802 in a circular shape on a substrate (e.g., a plate made of a film).

According to an embodiment, the magnet structure may further include a magnet piece in which the magnetic forces of the magnetized areas are different from the magnetic forces of the magnetized areas in the above-described magnet pieces 801 and 802. For example, in a third magnet piece, the third outer magnetized area and the third inner magnetized area may be configured to have a magnetic force different from M1 and M2. It is possible to configure a ring-shaped magnet structure by alternately arranging the first magnet piece 801, the second magnet piece 802, and the third magnet piece in a circular shape on the substrate.

According to an embodiment, when designing the magnet structure, M1 and M2 may be determined such that the first distance has as small a value as possible, the second distance has as small a value as possible, or there is no difference between the first distance value and the second distance value if possible.

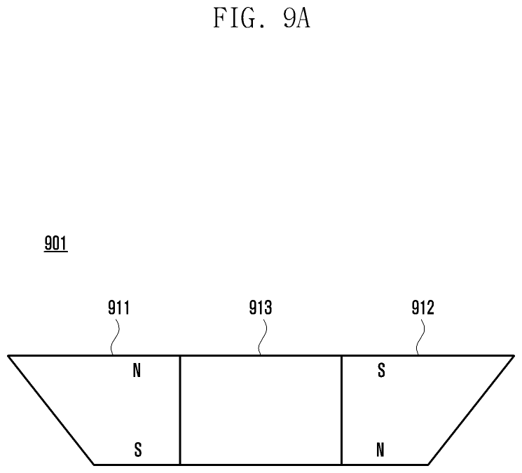

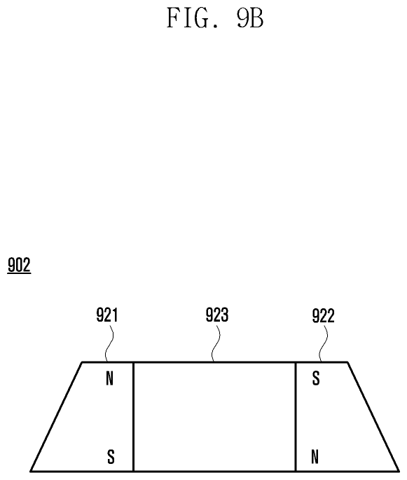

FIGS. 9A and 9B are cross-sectional views of a first magnet piece 901 and a second magnet piece 902, respectively, which are configured to have different shapes, according to an embodiment. The cross section of the first magnet piece 901 in FIG. 9A may correspond to a cross section of the magnet structure 610 taken along line B-B′ in FIG. 6a. The cross section of the second magnet piece 902 in FIG. 9B may correspond to a cross section of the magnet structure 610 taken along line C-C′ in FIG. 6a.

Referring to FIG. 9A, the first magnet piece 901 may include a first outer magnetized area 911 configured such that an N pole faces the first side, a first inner magnetized area 912 configured such that an S pole faces the first side, and a first non-magnetized area 913 disposed between the first outer magnetized area 911 and the first inner magnetized area 912. The first outer magnetized area 911 may be configured to have a shape of a first trapezoid. The first inner magnetized area 912 may be configured to have a shape of a second trapezoid that is laterally symmetrical to the first trapezoid. In the first outer magnetized area 911, the S pole may face the first side, and in the first inner magnetized area 912, the N pole may face the first side. When the first magnet piece 901 and the second magnet piece 902 are applied to the power supply device 201, the first side may be the front cover 311 (see FIG. 3). When the first magnet piece 901 and the second magnet piece 902 are applied to the power receiving device 202, the first side may be the rear cover 322 (see FIG. 3).

Referring to FIG. 9B, the second magnet piece 902 may include a second outer magnetized area 921 configured such that an N pole faces the first side, a second inner magnetized area 922 configured such that an S pole faces the first side, and a second non-magnetized area 923 disposed between the second outer magnetized area 921 and the second inner magnetized area 922. In the second outer magnetized area 921, the S pole may face the first side, and in the second inner magnetized area 922, the N pole may face the first side. The second outer magnetized area 921 may be configured to have a shape of a third trapezoid obtained by rotating the first trapezoid by 180 degrees with reference to a direction perpendicular to the direction in which the first side is oriented. The second inner magnetized area 922 may be configured to have a shape of a fourth trapezoid that is laterally symmetrical to the third trapezoid.

According to an embodiment, the first outer magnetized area 911 and the first inner magnetized area 912 may have a first cross-sectional area. The second outer magnetized area 921 and the second inner magnetized area 922 may have a second cross-sectional area that is different from (e.g., smaller than) the first cross-sectional area.

According to an embodiment, it is possible to configure a ring-shaped magnet structure (e.g., the magnet structure 401 of FIG. 4) by alternately arranging the first magnet pieces 901 and the second magnet pieces 902 in a circular shape on a substrate (e.g., a plate made of a film).

According to an embodiment, the magnet structure may further include a magnet piece in which the shape of the magnetized area is different from the shapes of the magnetized areas in the above-described magnet pieces 901 and 902. For example, the shape of the third outer magnetized area in the third magnet piece may be different from the first trapezoid and the third trapezoid. The shape of the third inner magnetized area in the third magnet piece may be different from the second trapezoid and the fourth trapezoid. It is possible to configure a ring-shaped magnet structure by alternately arranging the first magnet piece 901, the second magnet piece 902, and the third magnet piece in a circular shape on the substrate.

According to an embodiment, the first magnet piece and the second magnet piece may have different magnetic forces through a combination of the above-described embodiments. For example, referring again to FIGS. 6B and 6C, the first outer magnetized area 611 and the first inner magnetized area 612 may be configured such that W4-1 and W4-2 are different, and the second outer magnetized area 621 and the second inner magnetized area 622 may be configured such that W5-1 and W5-2 are the same. As another example, referring again to FIGS. 6B and 6C, the outer magnetized areas 611 and 621 and the inner magnetized areas 612 and 622 may be configured such that T2-1 and T2-2 are different. As another example, in the first magnet piece, the first outer magnetized area and the first inner magnetized area may have a first thickness and a first shape. In the second magnet piece, the second outer magnetized area and the second inner magnetized area may have a second thickness different from the first thickness and a second shape different from the first shape.

In the following description, a magnet structure configured to have no deviation in magnetic force will be referred to as a single magnet structure, and a magnet structure configured to have a deviation in magnetic force as described above will be referred to as a multi-magnet structure.

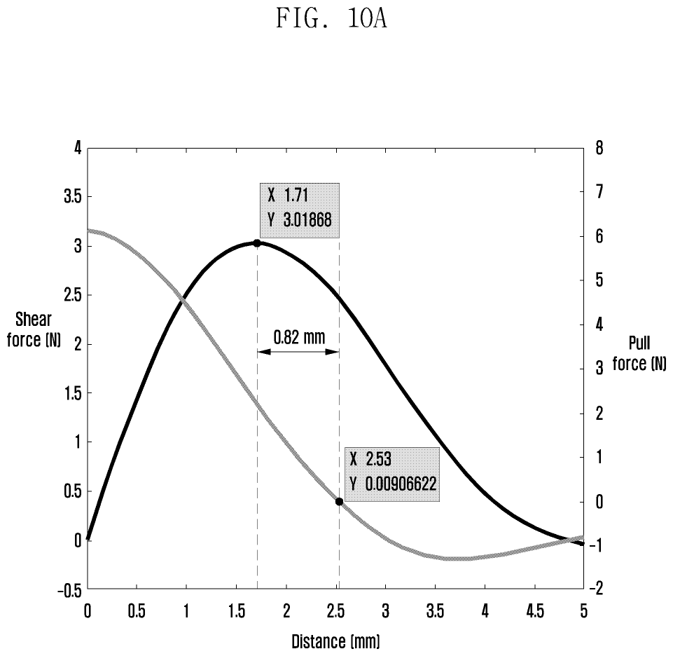

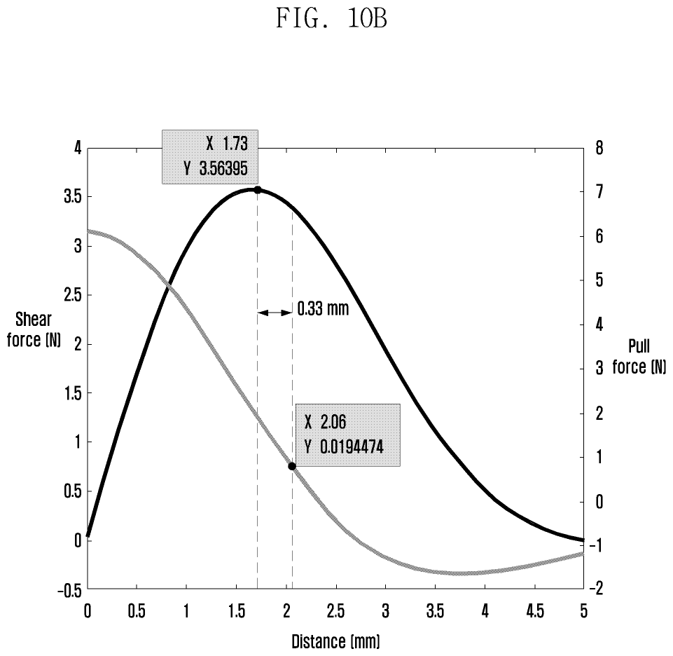

FIG. 10A illustrates changes in shear force and pull force depending on a change in the distance between the center of the first magnet structure and the center of the second magnet structure adjacent thereto when the first magnet structure is implemented as a single magnet structure. FIG. 10B illustrates changes in shear force and pull force depending on a change in the distance between the center of a third magnet structure and the center of a second magnet structure adjacent thereto when the third magnet structure is implemented as a multi-magnet structure.

A first magnet structure (single magnet structure) may be configured by arranging a plurality of magnet pieces in a circular shape on a substrate. In the first magnet structure, the widths (e.g., the length in the y-axis direction in FIG. 3) of the magnet pieces are all the same as about 4.05 mm. In all of the magnet pieces, the widths of the outer magnetized areas and the widths of the inner magnetized areas are the same as about 1.175 mm.

A third magnet structure (multi-magnet structure) is configured by arranging the first magnet pieces and the second magnet pieces alternately in a circular shape on a substrate. In the second magnet structure, the widths of the magnet pieces are all the same as about 3.65 mm. In the first magnet piece, the width of the first outer magnetized area is 2 mm, and the width of the first inner magnetized area is about 1 mm. In the second magnet piece, the width of the second outer magnetized area and the width of the second inner magnetized area are about 1.755 mm.

Referring to FIG. 10A, the maximum value of pull force is about 6N. The maximum value of shear force is 3.01868N and the first distance value is 1.71 mm. When the pull force is about zero, the second distance value is 2.53 mm. The difference between the two distance values is about 0.82 mm.

Referring to FIG. 10B, the maximum value of pull force is about 6N. The maximum value of shear force are 3.56395N, and the first distance value is 1.73 mm. When the pull force is about zero, the second distance value is 2.06 mm. The difference between the two distance values is about 0.33 mm. It can be seen that, when the magnet structure is implemented as a multi-magnet structure, the first distance value or the second distance value is reduced. It can be seen from FIGS. 10A and 10B that, when the magnet structure is implemented as a multi-magnet structure, the difference between the two distance values is relatively small. Therefore, when the magnet structure is implemented as a multi-magnet structure, a user may more easily separate the power receiving device from the power supply device. In addition, with reference to the same pull force, the widths of the magnet pieces are relatively narrow. Accordingly, the magnet structure can be made more compact. In addition, since the magnet pieces are relatively narrow in width, the magnetic force acting on electronic components (e.g., a digitizer) adjacent thereto is relatively weak, and thus malfunction of the electronic components can be prevented or reduced. With reference to the same width of the magnet pieces, it is possible to implement a multi-magnet structure with a magnetic body with a weaker magnetic force (e.g., a low-cost magnet).

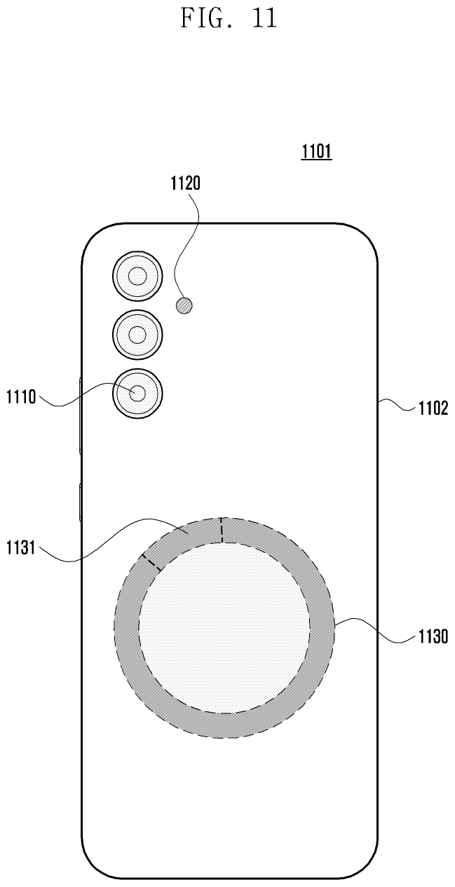

FIG. 11 illustrates the rear surface of an electronic device 1101 having a magnet structure configured according to an embodiment.

Referring to FIG. 11, the electronic device 1101 (e.g., the power receiving device 202 in FIG. 2) may include a plurality of cameras. The camera lenses 1110 may be exposed through the rear surface of the electronic device 1101. In addition, a flash 1120 may be exposed through the rear surface. A dual-magnet structure 1130 according to various embodiments described above may be configured inside the housing 1102 of the electronic device 1101. In the double-magnet structure 1130, among the magnet pieces, the magnet piece 1131 (e.g., 601, 701, 801, or 902), which is a magnetic body with a relatively weak magnetic force, may be disposed adjacent to the camera lenses 1110 and the flash 1120, and a magnetic piece (e.g., 602, 702, 802, or 901) which is a magnetic body with a relatively strong magnetic force may be disposed far from the camera lenses 1110 and the flash 1120. The magnetic force acting on the camera lenses 1110 and the flash 1120 is relatively weak, and thus malfunctions can be prevented or reduced.

According to an example embodiment, an electronic device (e.g., the power supply device 201 or the power receiving device 202) includes a housing including a first side of the electronic device and a second side opposite to the first side, a wireless charging coil disposed in the housing, and a magnet structure (e.g., the first magnet structure 330 or the second magnet structure 340) disposed in the housing to surround the coil and including a plurality of magnet pieces including a first magnet piece and a second magnet piece. The first magnet piece may include a first outer magnetized area having an N pole facing the first side, a first inner magnetized area disposed closer to the coil than the first outer magnetized area and having an S pole facing the first side, and a first non-magnetized area disposed between the first outer magnetized area and the first inner magnetized area. The second magnet piece may include a second outer magnetized area having an N pole facing the first side, a second inner magnetized area disposed closer to the coil than the second outer magnetized area and having an S pole facing the first side, and a second non-magnetized area disposed between the second outer magnetized area and the second inner magnetized area. The first magnet piece may have a first magnetic force, and the second magnet piece may have a second magnetic force different from the first magnetic force.

The first outer magnetized area may be magnetized with an S pole facing the second side. The first inner magnetized area may be magnetized with an N pole facing the second side. The second outer magnetized area may be magnetized with an S pole facing the second side. The second inner magnetized area may be magnetized with an N pole facing the second side.

The magnet structure may be formed by alternately arranging the first magnet piece and the second magnet piece in a circular shape on a substrate.

The first outer magnetized area and the first inner magnetized area may each have a first width. The second outer magnetized area and the second inner magnetized area may each have a second width different from the first width.

The first outer magnetized area and the first inner magnetized area may each have a first thickness. The second outer magnetized area and the second inner magnetized area may each have a second thickness different from the first thickness.

The size of the first outer magnetized area may be the same as the size of the second outer magnetized area. The size of the first inner magnetized area may be the same as the size of the second inner magnetized area.

The first outer magnetized area and the first inner magnetized area may be magnetized to have the first magnetic force. The second outer magnetized area and the second inner magnetized area may be magnetized to have the second magnetic force.

The first outer magnetized area may have a first width. The first inner magnetized area may have a second width different from the first width.

The first outer magnetized area may have a first thickness. The first inner magnetized area may have a second thickness different from the first thickness.

The magnetic force of the first outer magnetized area may be different from the magnetic force of the first inner magnetized area.

The first magnet piece may have a different shape from the second magnet piece.

Of the first magnet piece and the second magnet piece, the magnetic piece with a relatively weak magnetic force may be disposed closer to electronic components of the electronic device than the other magnet piece. The electronic components may include a camera.

The electronic device may further include a battery. The electronic device may be configured to charge the battery by using power received from an external electronic device via the coil.

The electronic device may be configured to receive power from a first external electronic device and to provide the received power to a second external electronic device via the coil.

A camera lens of the electronic device may be exposed through the first side or the second side.

According to an example embodiment, a portable electronic device (e.g., the power receiving device 202) includes a housing including a first side of the electronic device and a second side opposite to the first side, a wireless charging coil disposed in the housing, a display disposed in the housing and visible through the first side, a battery disposed in the housing, and a magnet structure (e.g., the second magnet structure 340) disposed in the housing to surround the coil and including a plurality of magnet pieces including a first magnet piece and a second magnet piece. The first magnet piece may include a first outer magnetized area having an N pole facing the first side, a first inner magnetized area disposed closer to the coil than the first outer magnetized area and having an S pole facing the first side, and a first non-magnetized area disposed between the first outer magnetized area and the first inner magnetized area. The second magnet piece may include a second outer magnetized area having an N pole facing the first side, a second inner magnetized area disposed closer to the coil than the second outer magnetized area and having an S pole facing the first side, and a second non-magnetized area disposed between the second outer magnetized area and the second inner magnetized area. The first magnet piece may have a first magnetic force, and the second magnet piece may have a second magnetic force different from the first magnetic force.

In the portable electronic device, the first outer magnetized area may each be configured to have an S pole facing the second side, the first inner magnetized area may each be configured to have an N pole facing the second side, the second outer magnetized area may each be configured to have an S pole facing the second side, and the second inner magnetized area may each be configured to have an N pole facing the second side.

In the portable electronic device, the magnet structure may be formed by alternately arranging the first magnet piece and the second magnet piece in a circular shape on a substrate.

In the portable electronic device, the first outer magnetized area and the first inner magnetized area may each be configured to have a first width, and the second outer magnetized area and the second inner magnetized area may each be configured to have a second width different from the first width.

In the portable electronic device, the first outer magnetized area and the first inner magnetized area may each be configured to have a first thickness, and the second outer magnetized area and the second inner magnetized area may each be configured to have a second thickness different from the first width.

In the above description, the prefixes “first”, “second”, and “third” are only used to distinguish the same name and do not have any special meaning such as importance or order.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

1. An electronic device comprising:
a housing comprising a first side of the electronic device and a second side opposite to the first side;
a wireless charging coil disposed in the housing; and
a magnet structure disposed in the housing to surround the coil and having a plurality of magnet pieces comprising a first magnet piece and a second magnet piece,
wherein the first magnet piece comprises:
a first outer magnetized area having an N pole facing the first side;
a first inner magnetized area disposed closer to the coil than the first outer magnetized area and having an S pole facing the first side; and
a first non-magnetized area disposed between the first outer magnetized area and the first inner magnetized area,
wherein the second magnet piece comprises:
a second outer magnetized area having an N pole facing the first side;
a second inner magnetized area disposed closer to the coil than the second outer magnetized area and having an S pole facing the first side; and
a second non-magnetized area disposed between the second outer magnetized area and the second inner magnetized area, and
wherein the first magnet piece has a first magnetic force and the second magnet piece has a second magnetic force different from the first magnetic force.

2. The electronic device of claim 1, wherein the first outer magnetized area has an S pole facing the second side,
wherein the first inner magnetized area has an N pole facing the second side,
wherein the second outer magnetized area has an S pole facing the second side, and
wherein the second inner magnetized area has an N pole facing the second side.

3. The electronic device of claim 1, wherein the magnet structure is formed by alternately arranging the first magnet piece and the second magnet piece in a circular shape on a substrate.

4. The electronic device of claim 1, wherein the first outer magnetized area and the first inner magnetized area are each configured to have a first width, and
wherein the second outer magnetized area and the second inner magnetized area are each configured to have a second width different from the first width.

5. The electronic device of claim 1, wherein the first outer magnetized area and the first inner magnetized area are each configured to have a first thickness, and
wherein the second outer magnetized area and the second inner magnetized area are each configured to have a second thickness different from the first thickness.

6. The electronic device of claim 1, wherein the first outer magnetized area has a size equal to a size of the second outer magnetized area,
wherein the first inner magnetized area has a size equal to a size of the second inner magnetized area,
wherein the first outer magnetized area and the first inner magnetized area are magnetized to have the first magnetic force, and
wherein the second outer magnetized area and the second inner magnetized area are magnetized to have the second magnetic force.

7. The electronic device of claim 1, wherein the first outer magnetized area is configured to have a first width, and
wherein the first inner magnetized area is configured to have a second width different from the first width.

8. The electronic device of claim 1, wherein the first outer magnetized area is configured to have a first thickness, and
wherein the first inner magnetized area is configured to have a second thickness different from the first thickness.

9. The electronic device of claim 1, wherein the first outer magnetized area has a magnetic force different from a magnetic force of the first inner magnetized area.

10. The electronic device of claim 1, wherein the first magnet piece has a different shape from a shape of the second magnet piece.

11. The electronic device of claim 1, wherein, among the first magnet piece and the second magnet piece, a magnet piece having a relatively weak magnetic force is disposed closer to an electronic component of the electronic device than the other magnet piece.

12. The electronic device of claim 11, wherein the electronic component comprises a camera.

13. The electronic device of claim 1, further comprising a battery,
wherein the electronic device is configured to charge the battery using power received from an external electronic device via the coil.

14. The electronic device of claim 1, wherein the electronic device is configured to receive power from a first external electronic device and to provide the received power to a second external electronic device via the coil.

15. The electronic device of claim 1, wherein the first side or the second side is a side where a camera lens of the electronic device is exposed.
